(19) United States
(12) Patent Application Publication
(10) Pub. No.: US 2005/0160006 A1
(43) Pub. Date: Jul. 21, 2005

(54) Model and process of assimilating, transmitting and disseminating an internet based comparative shopping tool for local grocery stores

(75) Inventor: Dale Richard Pate, Daytona Beach, FL (US)

Correspondence Address: Dale Pate, PO Box 265082, Daytona Beach, FL, 32126, US

(73) Assignee: BANCOT GLOBAL TECHNOLOGIES CORPORATION, Daytona Beach, FL (US)

(21) Appl. No.: 10/759,830

(22) Filed: Jan. 20, 2004

(51) Int. Cl. G06F 17/60

(52) U.S. Cl. 705/16; 705/22; 705/37

(57) ABSTRACT

A grocery shopper uses a web browser and connects to the invention's web site to comparatively grocery shop local supermarkets. The shopper chooses the area in which they wish to shop or compare grocery prices. The shopper may browse the chosen store to see the inventory and prices, or the shopper may chose to compare chosen items against other local grocery stores in their area. The shopper may choose to compile a shopping list and manually figure what and where to purchase items in order to save money, or the web site server can make a list, based upon the shoppers chosen items, and tell the shopper what and where to purchase items in order to save the shopper the most money possible.

### STATEMENT REGARDING FEDERALLY SPONSORED RESEARCH OR DEVELOPMENT

This invention was not federally sponsored Research or Development.

### BACKGROUND OF THE INVENTION

The field of endeavor of this invention pertains to internet based comparative grocery shopping of local supermarkets.

The general idea of this claimed invention is to allow any person who has access to the Internet, also known as the World Wide Web, to compare actual local grocery store inventories and the inventory's prices before or during a shopping experience. The overall objective is to show shoppers that they may be able to save money buy altering what and where they purchase grocery store goods. Currently, there is no means or avenue that informs an individual of the actual prices of local supermarket goods before, or during a shopping experience and this invention solves that.

### DETAILED DESCRIPTION OF THE INVENTION

Physical Properties of This Invention

1. Internet Connection.

2. Computer Server.

3. Structured Query Language (SQL) Database Containing:
a) Table containing fields for zip codes, area codes and address of all local grocery stores where information is being made available.
b) Table for each local supermarket's inventory containing fields for the price of each item, items unit price and the Uniform Product Code (UPC) of the item, or stock number, or some unique number that identifies that item.
c) Table containing fields for all known Uniform Product Codes (UPC) and the corresponding item's description, weight and size. When no Uniform Product Code is available for an item, a store stock Number, or a unique number will be generated to specifically identify the item.
d) Table containing all known Uniform Product Codes (UPC) used by grocery stores, stock number, or a unique number that specifically identifies it, and their known equivalents or similar item's Uniform Product Codes (UPC), stock number, or a unique number.
   Process of Operation and Usage of This Invention

First, the shopper enters the current internet web site address, or URL, that this invention uses into their Internet browser. The shopper is then asked to either enter the zip code, area code, or address of the area supermarkets they would like to compare prices in. As an alternative method the shopper may search graphically by clicking on a map of their desired shopping location. The shopper's request is then transmitted to the server where the zip code, area code, address, or map location is compared against the database and a corresponding list of actual local supermarkets in the shopper's chosen location is then returned to the shopper's web browser.

Second, the shopper must choose, or has previously chosen, which supermarkets they wish to compare prices with. The shopper chooses a particular supermarket and views its inventory and prices while simultaneously the shopper is shown the price of the viewed item at other supermarkets. At the shopper's request a list may be complied of chosen items and later those item's prices are later compared against other area supermarkets.

Items being compared are based upon exact matches of Uniform Product Codes contained in the database and when an exact match is not found equivalent products and their prices are shown. For Example, a 12-ounce can of Classic Coca Cola has a certain 14 digit Uniform Product Code that specifically identifies it. The database contains the Uniform Product Codes of previously determined equivalent products; in this example an equivalent product would be a 12-ounce generic brand cola, or a 12-ounce store brand cola. An alternate method to match items is to use exact matching, or best match, of product descriptions. For example, a shopper selects a Macintosh apple from the viewed grocery store and wishes to compare Macintosh apple prices at other area grocery stores. Since most grocery stores do not assign Uniform Product Codes to produce and no stock number is known the database searches to find all item descriptions to find the matching phrase “Macintosh apple” or the phrase “Macintosh apple” contained within the description. The database then searches all local grocery stores and returns a list that met the search criteria and the items prices.

As an alternative to selecting a store and then searching for the desired products the shopper may enter or upload to the server a list, made by the shopper, of Uniform Product Codes (UPC) and the Uniform Product Codes are matched against the database of that particular store's inventory's Uniform Product Codes. The server then returns a list of the Uniform Product Codes, which were submitted by the shopper, along with matching item's description, price, and unit price. In addition, the shopper is given the prices of those selected items, if available, at other local supermarkets. Upon command from the shopper the list maybe transmitted to the server upon which time the database compares all items selected by the shopper against all area grocery store prices. The database determines which grocery store has the lowest price for each of the shopper's items and recalculates the list, in order to save the shopper the most money possible, describing which items to buy and at what local grocery store.

Finally, the last method available to the shopper is to browse thru their chosen store's inventory and to select items in which they wish to compare or purchase. Upon command from the shopper the list is transmitted to the server upon which time the database compares all items selected by the shopper against other grocery store prices. The database determines which grocery store has the lowest price for each of the shopper's items and recalculates the list in order to save the shopper the most money possible.

What I claim as my invention is:

1. A method and process which allows a shopper to exam the inventories and inventory prices of their local grocery stores before they shop or during the shopping experience, and allow the shopper to methodically compare each local grocery store's inventory and prices and to make suggestions to the shopper of what and which grocery store to purchase their goods at in order to save money.

2. The method of claim 1, wherein: a shopper uses an internet browser connected via the internet to this invention's web site address and uses information contained within to conduct comparative shopping of local grocery stores.

3. The method of claim 1, wherein: a database that contains descriptive information of local grocery store inventories and the inventory's prices. Descriptive information is the Uniform Product Code, item description, item size or weight, price and unit price, table containing all known Uniform Product Codes of items used in any grocery store.
